(19) United States
(12) Patent Application Publication
(10) Pub. No.: US 2017/0335822 A1
(43) Pub. Date: Nov. 23, 2017

(54) WIND TURBINE WHICH CAN BE MOVED IN TRANSLATION

(71) Applicant: Jan Franck, Weidenberg (DE)

(72) Inventor: Jan Franck, Weidenberg (DE)

(21) Appl. No.: 15/504,860

(22) PCT Filed: Aug. 18, 2015
(86) PCT No.: PCT/IB2015/001384

§ 371 Date: Feb. 17, 2017

(30) Foreign Application Priority Data
Aug. 18, 2014 (DE) 10 2014 012 048.1

(51) Int. Cl. F03D 7/02; F03D 9/25; H02K 7/18; F03D 13/20; F03D 15/00; H02K 7/108

(52) U.S. Cl. CPC F03D 7/0204; F03D 15/00; H02K 7/108; H02K 7/1838; F03D 13/20; F03D 7/0224; F03D 9/255; F05B 2250/141; F05B 2240/941

(57) ABSTRACT

The invention is directed to a wind generator, comprising a wind turbine which is mounted so that it is rotatable about a horizontal or approximately horizontal rotational axis and which has one or more blades or other wind-guiding surfaces for converting flow energy of the wind into rotational energy, and at least one generator, coupled to the hub or shaft of the wind turbine or to the output shaft of a gear connected thereto, for converting the rotational energy into electrical energy, wherein the center of gravity of the wind turbine, together with the hub and rotor shaft and rotatable parts coupled thereto which rotate about the same rotational axis, is translationally movable in a direction completely or predominantly in parallel to the rotational axis of the wind turbine.

### REFERENCE TO PENDING PRIOR PATENT APPLICATIONS

This patent application claims benefit of International (PCT) Patent Application No. PCT/IB2015/001384, filed Aug. 18, 2015 by Jan Franck for WIND TURBINE WHICH CAN BE MOVED IN TRANSLATION, which claims benefit of German Patent Application No. DE 10 2014 012 048.1, filed Aug. 18, 2014, which patent applications are hereby incorporated herein by reference.

### FIELD OF THE INVENTION

The invention is directed to a wind generator, comprising a wind turbine which is mounted so that it is rotatable about a horizontal or approximately horizontal rotational axis, and which has one or more blades or other wind-guiding surfaces for converting flow energy of the wind into rotational energy, and at least one generator, coupled to the hub or shaft of the wind turbine, for converting the rotational energy into electrical energy.

### BACKGROUND OF THE INVENTION

To supplement and to reduce consumption of existing fuels, ever since the so-called energy transition there has also been increasing use of renewable energies, in particular wind energy.

However, the wind flow in many areas is somewhat sporadic, and it is not uncommon for periods with high wind to be interspersed with calm or windless phases. In addition, during periods with low wind, the massive rotor of a wind power plant often cannot be set in motion, so that wind energy plants generally are able to deliver energy only at higher wind speeds.

### SUMMARY OF THE INVENTION

The disadvantages of the described prior art have resulted in the object of the invention, to design a wind generator such that the incident relative wind speed is, or can be made to be, as high as possible.

This object is achieved in that the center of gravity of the wind turbine, together with the hub and rotor shaft and rotatable parts coupled thereto which rotate about the same rotational axis, is translationally or predominantly translationally movable. Translational movement is understood in particular to mean any movement that is allowed by such bearing or guiding in which the parts in question are movable, at least locally, in a horizontal or approximately horizontal direction, in particular in the direction of the rotary shaft of the wind turbine. In other words, the path of the translational movement may extend along a curve, and does not have to be straight. As the result of such a degree of freedom of movement, on the one hand there is the possibility of being able to immediately give way to extremely high winds and thus reduce the relative flow velocity. On the other hand, for example after such gusts have subsided, by means of a resetting movement of the wind turbine the relative flow velocity may be increased again, thus increasing the energy output. Use is made of the option for the wind turbine to be translationally driven in order to virtually increase the incident wind speed. When the most favorable available drive energy possible is utilized for this purpose, electrical energy may be generated even when there is little or no wind flow. In this regard, other flow energies come into consideration as primary energy, for example water flow in a river (hydropower) or in coastal areas (tidal power), or vertical air flow (convection energy), optionally assisted by electrical energy or other fossil fuels, for example for purposes of start-up. However, as described in greater detail below, it is conceivable to also utilize wind energy as primary energy for the translational movement according to the invention.

It has been found to be advantageous for the translational movement of the wind generator to take place guided in parallel to the surface area of a subsurface, in particular guided in parallel to a preferably horizontal plane. Since the wind almost always blows predominantly horizontally, it may thus be ensured that the prevailing wind direction and the translational movement lie within the same plane, for example approximately within a horizontal plane.

In addition, the wind resistance of the wind turbine or of parts thereof may be adjustable, in particular in that the setting angle of one or more blades or other wind-guiding surfaces is changeable, or in that the wind turbine is pivotable with respect to the incident flow direction, or in that a preferably streamlined cowling is pivotable in front of the wind turbine. The conversion of wind energy into rotational energy can be controlled in this way. In this regard, the measures, listed by way of example, for influencing the wind resistance have different effects on the degree of conversion:

If the blades or other wind-guiding surfaces are preferentially set transversely with respect to the wind direction, the wind resistance and also the degree of conversion of wind energy into rotational energy increase; if these blades or wind-guiding surfaces are preferentially set in parallel to the wind direction, the wind resistance and also the degree of conversion of wind energy into rotational energy decrease.

If the rotational axis of the wind turbine is set at a preferably steep angle against the wind direction, in the ideal case antiparallel to the wind direction, the wind resistance and also the degree of conversion of wind energy into rotational energy increase; if the wind turbine is turned away from the wind, i.e., the intermediate angle between the wind direction and the rotational axis of the wind turbine is increased, the wind resistance and at the same time also the degree of conversion of wind energy into rotational energy decrease.

Lastly, if a streamlined cowling is pivoted in front of the wind turbine, on the one hand the wind resistance increases, and on the other hand the energy output, i.e., the degree of conversion of wind energy into rotational energy, decreases.

From this it is known that, depending on the measure, the change ratio between the wind resistance and the energy output may be in the same direction; i.e., with increasing wind resistance the energy output also increases, but may also be in opposite directions; i.e., with increasing wind resistance the energy output decreases.

The invention may be implemented, for example, by the wind generator having a mobile design, in particular by means of wheels on the bottom. It is thus possible to move a wind turbine as necessary, and to thus generate a velocity with respect to the surrounding air which allows the rotor to start/run and generate power.

It has proven to be advantageous for the wind generator to be situated onboard a vehicle. This may be a preferably motorized road vehicle or a rail vehicle.

The invention may be refined in that the vehicle can travel on rails. In such cases, a translational movement in the direction of the rails is possible, but another movement transverse thereto is not.

Furthermore, the teaching of the invention provides that the rails are laid in a circle. A vehicle or chassis guided thereon can thus travel in both directions for an unlimited period of time.

It is within the scope of the invention that the rails are mounted on a tower or some other elevated structure. The wind turbine is thus situated at a higher level than the surrounding terrain, where higher wind speeds naturally prevail, so that an increased energy output is achievable.

The wind generator and/or its wind turbine should not be coupled in terms of rotational movement to one of the bottom-side wheels. In other words, the rotational energy of the wind turbine should not, or should not directly, be transmitted to the bottom-side wheels, since in such cases the efficiency of the system would be reduced.

The invention may be refined by eccentrically mounting the nacelle so that it is rotatable or pivotable about a vertical pivot axis. For such a nacelle that is guided above the ground surface, the rails laid along the circumference of a circle are replaced by a central bearing about a vertical pivot axis.

In the invention it is recommended that the nacelle is eccentrically mounted so that it is pivotable in a circle about a vertical pivot axis, the rotational axis of the wind turbine being oriented approximately tangentially with respect to the circle described by the nacelle. In such cases, there is a maximum coupling between the incident wind energy and the rotational energy converted therefrom.

The vehicle or chassis or the nacelle is preferably provided with or coupled to a device, in particular a motor, for translationally driving same. An actively influenceable power flow to/from a motor provides the option of controlling or even regulating the translational movement corresponding to certain requirements.

The drive device may be designed as an internal combustion engine, as an electric motor, or as a propeller that is mounted so that it is rotatable about a vertical axis, and driven by a preferably upwardly directed convection flow. The type of motor depends on the type of primary energy used. The motor may be coupled in various ways in order to set the wind energy plant in translational movement. On the one hand, the bottom-side wheels of a vehicle or chassis may be driven directly by the motor, from which the translational movement of the vehicle or chassis is indirectly derived. On the other hand, the motor may be connected or coupled to the undercarriage of the vehicle or the chassis in order to drive it forward. On the one hand, a bracket or boom which connects a centrally situated motor to the vehicle or chassis that is movable along a circumferential periphery is conceivable; on the other hand, the coupling between the motor and the vehicle or chassis could also be established via a traction means, for example a cable, which extends along the length of the vehicle or chassis.

Further advantages result from the fact that the projection of the center of gravity of the device, in particular the motor, for driving the chassis or vehicle or the nacelle is situated within a circle described by the vehicle or chassis or the nacelle during its movement, preferably at or near the midpoint of the circle. The motor could be situated onboard the vehicle or chassis; however, in such an arrangement the motor is preferably stationary, and thus does not move with the vehicle and instead is only coupled thereto. Due to its central position, the motor does not have to follow the vehicle or chassis or the nacelle, and instead remains coupled thereto via traction, thrust, or swivel means.

One preferred arrangement is characterized in that the projection of the center of gravity of the device, in particular the motor, for driving the vehicle is situated on the subsurface guiding the vehicle, outside a polygon spanned by the contact areas of the bottom-side wheels on the subsurface, which may implemented, for example, by the drive means being situated not onboard the vehicle, but instead at an external location.

On the other hand, the projection of the center of gravity of the wind turbine or wind generator onto the subsurface guiding the vehicle should be situated within a polygon spanned by the contact areas of the bottom-side wheels on the subsurface. In other words, the wind turbine is mounted onboard the vehicle or chassis, and for reasons of maximum stability a symmetrical weight distribution is sought, the wind turbine or the entire wind generator being situated preferably centrally on the vehicle or chassis.

In order to always be able to capture maximum incident air at any orientation of the wind turbine, a wind turbine according to the invention should not be situated within a wind tunnel or surrounded by wind deflector plates. In addition, a wind tunnel or the like could provide an increased wind exposure area in the event of an angled incident wind flow, thus entailing the risk of instability.

The diameter of the wind turbine should be greater than the largest width of the vehicle or chassis, in particular greater than the lateral distance between two bottom-side wheels thereof on different sides of the vehicle or chassis. In this way, maximum wind energy may be captured and converted into rotational energy.

Multiple chassis or nacelles may be guided at the same time on a guide device, i.e., on rails or on a vertical pivot axis. The efficiency of the system may be further increased in this way, since the energy output generally is approximately proportional to the number of wind turbines or wind generators.

The invention further provides that multiple chassis or nacelles guided on the same guide device are connected or coupled to one another in order to undergo synchronous movements. Such a connection on the one hand results in synchronicity of the movements, only with a phase shift, and on the other hand provides the option of being able to transmit forces between the various chassis or nacelles, in particular also drive forces for the translational movement according to the invention.

The sides of the wind turbines to be acted on by incident wind flow on multiple chassis or nacelles may point in the local directions corresponding to the same movement direction of the connecting means. In other words, these local directions are in each case situated, for example, on the front side, viewed in the movement direction. For circular guiding, i.e., with rails laid in a circle or with a central pivot axis, the wind turbines in question are then in each case situated, for example, at the front in the clockwise direction, or alternatively, in each case at the rear in the clockwise direction. For a joint circulation under calm conditions, all wind turbines then experience approximately equal incident flow; in contrast, when there is wind flow, with two wind turbines one wind turbine is always driven by the wind, while the other is at the same time decelerated.

On the other hand, there is also an arrangement in which the sides of the wind turbines to be acted on by incident wind flow on multiple chassis or nacelles point in the local directions corresponding to opposite movement directions of the connecting means. This would result in a circulation position in which both wind turbines face the incident air of the wind, and are thus set in rotation by same.

The invention may be refined in that the blades of a wind turbine are adjustable about their longitudinal axes in order to be adaptable to different relative speeds of the incident air. This function is primarily advantageous for wind when the wind turbine translationally moves along an arched curve, and the relative incident flow velocity of the air accordingly changes.

When the blades of a wind turbine are continuously adjustable, i.e., adjustable over arbitrary, unlimited setting angles, an adaptation may also be made to a reversal of the direction of relative rotation with respect to the incident air.

When multiple wind turbines are coupled to one another in terms of movement and connected to one another for force transmission, regulation may be implemented which always orients multiple, preferably two, mutually connected wind turbines against the wind, in that the setting angle of the blades of the front wind turbine in the particular incident flow direction is in each case adjusted in such a way that the wind resistance of this wind turbine is increased, and is thus reduced by the incident wind. Since only minimal energy is required for adjusting the setting angles of the blades, the efficiency of the system may thus be improved; the actual energy for orienting the wind turbines is supplied by the wind itself.

A wind energy plant according to the invention preferably includes a device for feeding the obtained electrical energy as current into a power grid, in particular an alternating current power grid or three-phase power grid. For transmitting higher levels of power, it is essential that the wind energy plant according to the invention is connected to the power grid by a cable, at least by a two-wire cable in the case of alternating current power delivery, or at least by a three-wire cable in the case of three-phase current power delivery. For circulating arrangements, it may be necessary to transport the current from a wind generator to a stationary connecting cable via slip rings.

In Central Europe, public three-phase power grids and alternating current power grids as a part of same are operated at a frequency of 50 Hz, whereas other countries such as the United States operate at 60 Hz. In any case, a device for synchronizing the current, to be fed, with the frequency of the voltage in the alternating current power grid or three-phase power grid is necessary. For this purpose, the current generated in a wind generator is typically transformed by an inverter or a converter to the frequency in question, and then injected into the grid, against the grid voltage. For this purpose, the grid voltage is customarily sampled, and on this basis the desired phase position of the current, and then also its amplitude, are computed, and the inverter or converter is then appropriately controlled, which takes place by suitable clocking of the current valves.

According to the invention, it may be further provided that a freewheel is situated between a wind turbine and the electric generator associated therewith, so that in the event of a countergust, the electric generator, despite the decelerated wind turbine, can continue to rotate freely in a practically undecelerated manner. In such cases, no energy is withdrawn from the rotating generator due to a countergust, thus further optimizing the efficiency.

Furthermore, a device for deflecting countergusts or other types of air flow that are unfavorable for the normal rotational direction of the wind turbine may be provided at the wind turbine, preferably upstream or downstream therefrom. For example, a circulating wind turbine may be acted on with incident flow from behind instead of from the front, as is customary, during its return. This reversed incident flow direction would decelerate the wind turbine, and therefore such an uncommon wind incident flow should be kept away from the wind turbine during a return. This may be achieved by deflecting this flow.

Lastly, according to the teaching of the invention, the device for deflecting countergusts or other types of air flow that are unfavorable for the normal rotational direction of the wind turbine is designed as a lamella-like curtain whose lamellae are open for a normal incident flow direction of the air, but closed for the opposite incident flow direction of the air.

It is conceivable to provide a plurality of mutually parallel lamellae, each having a horizontal longitudinal axis. Each lamella is mounted so that it is pivotable about one of its longitudinal edges, in particular about the top longitudinal edge in each case, for example in a lateral mounting. Under usual flow conditions, the lamellae are controlled by the wind to assume an approximately horizontal position, so that the interspaces between the lamellae are open and the wind can flow essentially unhindered up to the wind turbine in order to drive it in the usual rotational direction. Under “unusual” flow conditions, however, the lamellae fall into an approximately vertical plane; however, due to stop elements at that location the lamellae are not able to pivot further, and instead remain in this plane and therefore jointly close the entire incident flow area, i.e., keep the unfavorable wind away from the wind turbine. The wind turbine therefore is not decelerated. In addition, the back-pressure of the wind which now acts on the lamellae may be used as a translational drive until the wind turbine in question, which is translationally accelerated in this way, once again reaches an area with typical wind conditions, and can then draw rotational energy from same, which is ultimately converted into electrical energy.

### BRIEF DESCRIPTION OF THE DRAWINGS

Further features, particulars, advantages, and effects based on the invention result from the following description of one preferred embodiment of the invention, with reference to the drawings, which show the following:

FIG. 1 shows a wind power plant having a wind turbine and wind generator that are movable on rails;

FIG. 2 shows another wind power plant having two wind turbines that are movable on rails, together with one wind generator each, with automatic regulation of the azimuthal orientation against the wind being implemented; and

FIG. 3 shows another modified wind power plant having two wind turbines that are movable on rails, together with one wind generator each, the wind turbines being provided with variable flow panels in order to keep unfavorable flow conditions away from the wind turbine in question.

### DETAILED DESCRIPTION OF THE PREFERRED EMBODIMENTS

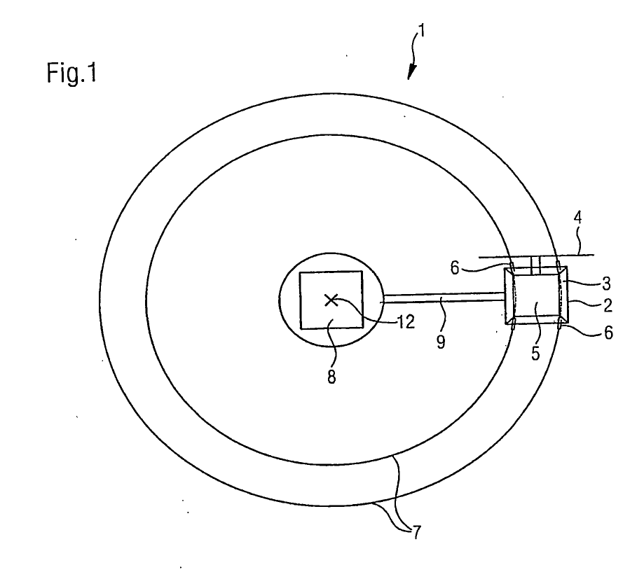

The mobile wind power plant 1 according to the invention according to FIG. 1 comprises a chassis 2 with a framework 3 for a wind turbine 4, and an electric generator 5 that is coupled thereto, for example via a gear.

Wheels 6 having wheel rims that are movable on rails 7 are mounted on the chassis 2. The wind power plant 1 may be moved along the rails 7 in this way.

A drive for the chassis 2 may be provided, for example by means of a motor coupled thereto or by means of a boom 9 coupled to a motor 8 that is centrally situated within a circular rail track.

Instead of a motor 8, it is also possible to provide some other type of drive, for example a convection turbine having a vertical axis, so that use may be made of ascending heated air as drive energy in order to increase the incident flow velocity, in particular when there is little or no air flow.

One advantage of the invention is that the wind turbine 4 together with the chassis 2 may be moved backwards along the rails 7 when the wind is too strong, so that the incident flow velocity is virtually reduced. When the wind speed decreases, the chassis 2 together with the wind turbine 4 may then be moved forward once again, thus virtually increasing the incident flow velocity. Overall, a relatively constant virtual incident flow velocity may thus be achieved.

In the drawing, the wind turbine 4 is situated eccentrically with respect to the chassis 2, i.e., not above the center of gravity of the chassis. However, this may be modified within the scope of another arrangement, in particular in such a way that the center of gravity of the overall arrangement made up of the chassis 2, framework 3, wind turbine 4, and electric generator 5 is situated approximately in the center of the area spanned by the four wheels 6, thus minimizing the risk of tipping.

Tipping of the chassis 2 together with its superstructures may also be counteracted by the rails 7 having not only an upper running track, but also a lower running track, which is engaged from below by suitably guided wheels 6.

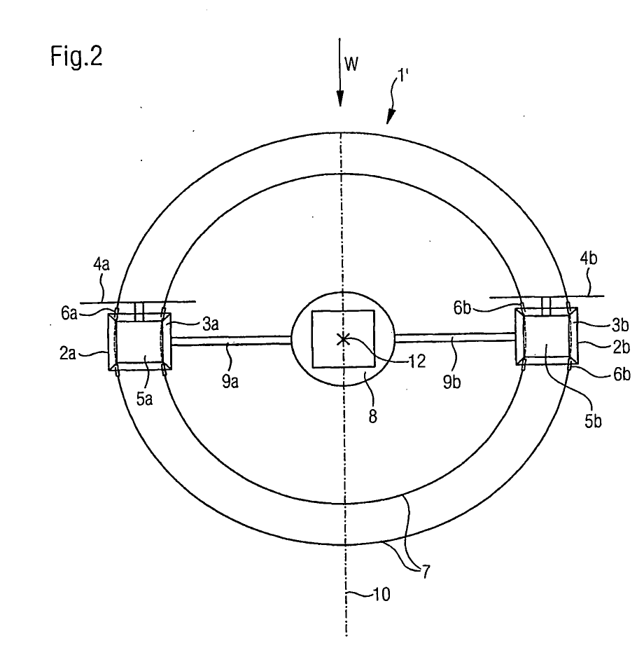

FIG. 2 shows a refinement of the arrangement according to FIG. 1. Two chassis 2a, 2b are hereby provided in each case, each bearing one wind turbine 4a, 4b and one electric generator 5a, 5b, respectively. The arrangement is mirror-symmetrical with respect to an axis of symmetry 10 that passes exactly between the two chassis 2a, 2b.

Optimal incident flow by the wind is provided when the wind direction is parallel to the axis of symmetry 10. The flow conditions are then also symmetrical with respect to one another with good approximation, as are the forces acting on the two wind turbines 4a, 4b. These forces are thus evenly balanced.

Since the two chassis 2a, 2b are rigidly connected to one another by the booms 9a, 9b, the chassis always assume diametrically opposed positions with respect to one another along the circular rail track 7, relative to the midpoint thereof, where the central motor 8 is situated.

The overall arrangement made up of the chassis 2a, 2b and booms 9a, 9b is intrinsically rigid, and therefore can at best oscillate back and forth about a central axis, with the two chassis 2a, 2b traveling along the rails 7. Use may be made of this characteristic for an automatic orientation of the two wind turbines 4a, 4b with regard to the incident wind or air flow.

This may be achieved, among other ways, in that the setting angles of the blades of the particular wind turbine 4a, 4b, which is situated on the particular front chassis 2a, 2b with respect to the wind, are set to be flatter, i.e., in a plane transverse to the instantaneous wind direction. The surface area of this wind turbine 4a, 4b exposed to the wind thus increases, resulting in a torque that once again pushes the wind turbine 4a, 4b in question backwards, while the other wind turbine 4b, 4a then once again moves forward along the circular path 7. The force or drive energy required for this purpose is supplied by the wind.

Moreover, doubling or quadrupling the number of wind turbines 4a, 4b naturally results in a corresponding increase in the power conversion.

Whereas for the wind power plant 1′ according to FIG. 2, the overall arrangement is usually in equilibrium and therefore always undergoes only small compensating movements, the wind power plant 1″ is optimized for circulating operation at a rotational speed D, in particular also with an incident wind W.

Thus, since the overall arrangement made up of the wind turbines 4a, 4b, chassis 2a, 2b, and booms 9a, 9b rotates about the midpoint of the circular rail track 7, one of the two wind turbines 4a, 4b always faces the wind W, whereas the respective other wind turbine faces away at exactly the same point in time, i.e., is acted on by incident wind from behind, which would decelerate the rotation of this wind turbine 4a, 4b.

Such a disadvantageous effect may be avoided, for example, by a freewheel being situated in each case between a wind turbine 4a, 4b and the associated electric generator 6a, 6b, the freewheel transmitting only driving torques in the usual rotational direction, but not decelerating torques.

To avoid deceleration of a wind turbine 4a, 4b, in addition, one lamella-like curtain 11a, 11b may be provided in the area of each respective chassis 2a, 2b, in close proximity behind a wind turbine 4a, 4b.

The lamella-like curtains 11a, 11b are designed in such a way that an incident wind acting on the wind turbine 4a, 4b in question from the front can deflect the lamellae, which are pivotable about their longitudinal edges, preferably about their upper longitudinal edges, backwards, i.e., in the wind direction W. The lamellae thus pivot out of a shared plane and orient in parallel to one another, resulting in a large interspace between adjacent lamellae which allows the wind to pass through essentially unhindered.

However, if the wind direction W is from the opposite direction, the lamellae are prevented from correspondingly pivoting away in the other direction by means of stop elements. The lamellae thus remain in a shared plane, the lamella curtain remains closed, and the wind cannot pass through up to the wind turbine 4a, 4b in question, and thus also cannot decelerate the wind turbine.

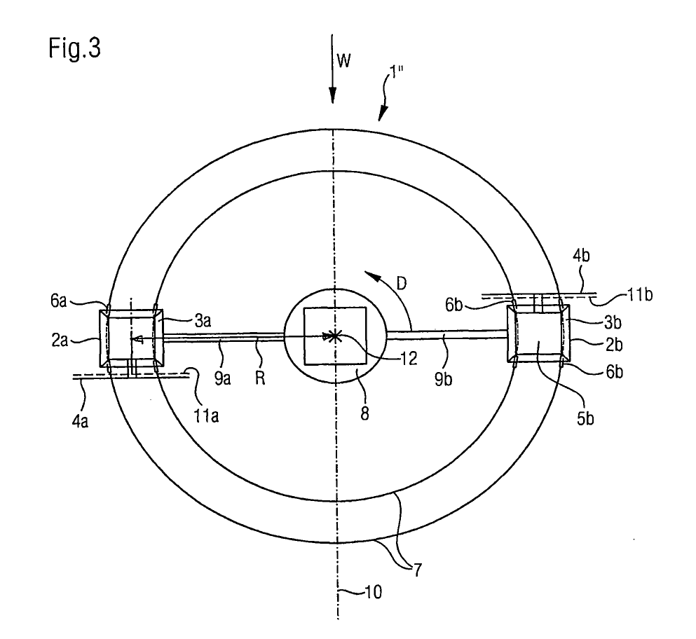

At the same time, the back-pressure of the wind W acting on the closed lamella curtain delivers a torque which drives the overall arrangement made up of the chassis 2a, 2b, wind turbines 4a, 4b, and electric generators 6a, 6b in the direction of circulation, and which drives the respective front wind turbine 4a, 4b against the wind, so that in the position shown in FIG. 3, a maximum virtual flow S results that is given by

S=W+D*2πR,

where R stands for the average distance of a wind turbine 4a, 4b from the midpoint 12 of the circular rail track 7.

While the summand D*2πR remains approximately constant, regardless of the particular position of the chassis 2a, 2b in question, the influence of the summand W depends on the instantaneous position of the wind turbine 4a, eb ab in question, for example according to a sine or cosine function, resulting in incident flow approximately as follows:

S=W*sin α+D*2πR,

where α is the angle of revolution, relative to a zero point on the leg of the axis of symmetry 10 facing away from the wind W.

A freewheel, described above, as well as the lamella curtain 11a, 11b also described above, prevent a decelerating effect, in particular if the factor sin α is less than zero. In this case, the following always applies:

S>D*2πR,

since W*sin α is canceled out for values less than zero. The lamella curtain 11a, which is situated to the left of the line of symmetry 10 in each case in FIG. 3 and is closed, delivers the driving torque, and captures the incident air and distributes it to both wind turbines 4a, 4b via the booms 9a, 9b.

This higher virtual flow S results in a higher rotational speed of the wind turbine 4a, 4b, resulting, among other things, in easier start-up of the system.

In another, alternative embodiment, the wind power plant 1 may have a miniaturized design and may be situated onboard a vehicle that is suitable for roadway travel, so that this vehicle is able to generate current from its kinetic energy, for example during a braking operation. For this purpose, such a wind power plant is preferably situated within the vehicle body, for example beneath the hood, and when necessary may be switched on as soon as excess kinetic energy is available, such as during a braking operation or during downhill travel. For this purpose, the wind turbine may be concealed behind a streamlined cowling which may be opened as needed, but which is closed during acceleration operations so as not to generate air resistance.

### LIST OF REFERENCE NUMERALS

1 wind power plant

2 chassis

3 framework

4 wind turbine

5 electric generator

6 wheels

7 rails

8 motor

9 boom

10 axis of symmetry

11 lamella curtain

12 midpoint

1. A wind generator, comprising a wind turbine which is mounted so that it is rotatable about a horizontal or approximately horizontal rotational axis, and which has one or more blades or other wind-guiding surfaces for converting flow energy of the wind into rotational energy, and at least one generator, coupled to the hub or shaft of the wind turbine or to the output shaft of a gear connected thereto, for converting the rotational energy into electrical energy, characterized in that the center of gravity of the wind turbine, together with the hub and rotor shaft and rotatable parts coupled thereto which rotate about the same rotational axis, is translationally movable in a direction completely or predominantly in parallel to the rotational axis of the wind turbine.

2. The wind generator according to claim 1, characterized in that the translational movement of the wind generator takes place guided in parallel to the surface area of a subsurface, in particular guided in parallel to a preferably horizontal plane.

3. The wind generator according to claim 1, characterized in that the wind resistance of the wind turbine or of parts thereof is adjustable, in particular in that the setting angle of one or more blades or other wind-guiding surfaces is changeable, or in that the wind turbine is pivotable with respect to the incident flow direction, or in that a preferably streamlined cowling is pivotable in front of the wind turbine.

4. The wind generator according to claim 1, characterized in that the wind generator has a mobile design, in particular by means of bottom-side wheels.

5. The wind generator according to claim 4, characterized in that the wind generator and/or the wind turbine are/is situated on a chassis and/or onboard a vehicle or a nacelle.

6. The wind generator according to claim 5, characterized in that the chassis or vehicle can travel on rails.

7. The wind generator according to claim 6, characterized in that the rails are laid in a circle.

8. The wind generator according to claim 7, characterized in that the rails are mounted on a tower or some other elevated structure.

9. The wind generator according to claim 4, characterized in that the wind generator and/or its wind turbine are/is not coupled in terms of rotational movement to one of the bottom-side wheels.

10. The wind generator according to claim 5, characterized in that the nacelle is eccentrically mounted so that it is pivotable about a vertical pivot axis.

11. The wind generator according to claim 10, characterized in that the nacelle is eccentrically mounted so that it is pivotable in a circle about a vertical pivot axis, the rotational axis of the wind turbine being oriented approximately tangentially with respect to the circle described by the nacelle.

12. The wind generator according to claim 5, characterized by a device, in particular a motor, for driving the vehicle or chassis or the nacelle.

13. The wind generator according to claim 12, characterized in that the drive device is designed as an internal combustion engine, as an electric motor, or as a propeller that is mounted so that it is rotatable about a vertical axis, and is driven by a preferably upwardly directed convection flow.

14. The wind generator according to claim 12, characterized in that the projection of the center of gravity of the device, in particular the motor, for driving the chassis or vehicle or the nacelle is situated within a circle described by the vehicle or chassis or the nacelle during its movement, preferably at or near the midpoint of the circle.

15. The wind generator according to claim 12, characterized in that the projection of the center of gravity of the device, in particular the motor, for driving the vehicle or chassis is situated on the subsurface guiding the vehicle, outside a polygon spanned by the contact areas of the bottom-side wheels on the subsurface.

16. The wind generator according to claim 4, characterized in that the projection of the center of gravity of the wind turbine or wind generator onto the subsurface guiding the vehicle is situated within a polygon spanned by the contact areas of the bottom-side wheels on the subsurface.

17. The wind generator according to claim 1, characterized in that the wind turbine is not situated within a wind tunnel or surrounded by wind deflector plates.

18. The wind generator according to claim 5, characterized in that the diameter of the wind turbine is greater than the largest width of the vehicle or chassis, in particular greater than the lateral distance between two bottom-side wheels thereof on different sides of the vehicle or chassis.

19. The wind generator according to claim 5, characterized in that multiple chassis or nacelles are guided at the same time on a guide device.

20. The wind generator according to claim 19, characterized in that multiple chassis or nacelles guided on the same guide device are connected or coupled to one another in order to undergo synchronous movements.

21. The wind generator according to claim 20, characterized in that the sides of the wind turbines, which are acted on by incident wind (W) on multiple chassis or nacelles, point in the local directions corresponding to the same movement direction of the connecting means.

22. The wind generator according to claim 20, characterized in that the sides of the wind turbines, which are acted on by incident wind (W) on multiple chassis or nacelles, point in the local directions corresponding to opposite movement directions of the connecting means.

23. The wind generator according to claim 1, characterized in that the blades of a wind turbine are adjustable about their longitudinal axes in order to be adaptable to different relative speeds of the incident air.

24. The wind generator according to claim 23, characterized in that the blades of a wind turbine are continuously adjustable, i.e., adjustable over arbitrary, unlimited setting angles, in order to be adaptable to a reversal of the direction of relative rotation with respect to the incident air.

25. The wind generator according to claim 1, characterized by regulation which always orients multiple, preferably two, mutually connected wind turbines against the wind (W), in that the setting angle of the blades of the front wind turbine in the particular incident flow direction is in each case adjusted in such a way that the wind resistance of this wind turbine is increased, and is thus reduced by the incident wind (W).

26. The wind generator according to claim 1, characterized by a device for feeding the obtained electrical energy as current into a power grid, in particular an alternating current power grid or three-phase power grid.

27. The wind generator according to claim 26, characterized by a device for synchronizing the current, to be fed, with the frequency of the voltage in the alternating current power grid or three-phase power grid.

28. The wind generator according to claim 1, characterized in that a freewheel is situated between a wind turbine and the electric generator associated therewith, so that in the event of a countergust, the electric generator, despite the decelerated wind turbine, can continue to rotate freely in a practically undecelerated manner.

29. The wind generator according to claim 1, characterized in that a device for deflecting countergusts or other types of air flow that are unfavorable for the normal rotational direction of the wind turbine is provided at the wind turbine, preferably upstream or downstream therefrom.

30. The wind generator according to claim 29, characterized in that the device for deflecting countergusts or other types of air flow that are unfavorable for the normal rotational direction of the wind turbine is designed as a lamella-like curtain whose lamellae are open for a normal incident flow direction of the air, but closed for the opposite incident flow direction of the air.
